(19) United States
(12) Patent Application Publication
(10) Pub. No.: US 2006/0130774 A1
(43) Pub. Date: Jun. 22, 2006

(54) Stacking structure for breeding chests

(76) Inventor: Michael Chiang, Hsin-Chuang City (TW)

Correspondence Address: BIRCH STEWART KOLASCH & BIRCH, PO BOX 747, FALLS CHURCH, VA, 22040-0747, US

(21) Appl. No.: 10/995,313

(22) Filed: Nov. 24, 2004

(51) Int. Cl. A01K 63/00

(52) U.S. Cl. 119/455

(57) ABSTRACT

A stacking structure for breeding chests includes a plurality of mounting members, a plurality of holding members and a plurality of first bracing rods. The mounting members are detachably coupled on the upper edge of a lower layer breeding chest. Each of the first bracing members is detachably bridged one mounting member and one holding member to support the bottom of a upper layer breeding chest. The holding members are bridged by a plurality of second bracing members in a detachable manner to increase the supporting capability for the upper layer breeding chest. By bridging the mounting members and the holding members, the first bracing rods form an access space therebetween to enable breeders to do feeding, clearing or repairing tasks without removing the upper layer breeding chest.

### FIELD OF THE INVENTION

The present invention relates to a stacking structure for breeding chests and particularly to stacking structure for breeding chests that provides an access space to allow breeders to access the breeding chests.

### BACKGROUND OF THE INVENTION

Referring to FIGS. 1 and 2, a conventional stacking structure for breeding chests generally include a plurality of mounting/holding members 100 each has a coupling trench 102 on the bottom to couple with the upper edge of a lower layer breeding chest 10. The mounting/holding members 100 are mounted onto the lower layer breeding chest 10. Each mounting/holding member 100 further has a boss 104 to wedge in a corresponding cavity (not shown in the drawings) formed on a upper layer breeding chest 12 to brace the bottom of the upper layer breeding chest 12. The mounting/holding member 100 has a retaining flange 106 extended vertically from the outer side of the top to cover the side wall of the upper breeding chest 12 to increase the anchoring effect. By means of such a structure, the upper layer breeding chest 12 may be stacked on the lower layer breeding chest 10.

The height of the boss 104 must mate the depth of the cavity (not shown in the drawings) of the upper layer breeding chest 12 and thus is restricted. After the upper layer breeding chest 12 has been stacked on the lower layer breeding chest 10, a narrow gap 14 is formed therebetween to allow pets held in the lower layer breeding chest 10 to breathe. To do the tasks of feeding, clearing or repairing in the lower layer breeding chest 10, the breeder has to remove the upper layer breeding chest 12.

### SUMMARY OF THE INVENTION

The object of the present invention is to provide a stacking structure that has an access space to facilitate feeding, clearing or repairing without disassembling the lower and upper layer breeding chests.

To achieve the foregoing object, the stacking structure of the invention mainly includes a plurality of mounting members, a plurality of holding members and a plurality of first bracing rods. The mounting members are detachably mounted onto the upper edge of a lower breeding chest. The holding members hold the bottom of a upper layer breeding chest. The first bracing rods are detachably bridged the corresponding the mounting members and the holding members to form an access space between the two breeding chests.

By means of the construction set forth above, a plurality of breeding chests may be stacked one upon another. The first bracing rods space the upper layer breeding chest and the lower layer breeding chest to form an access space therebetween so that breeders can do feeding, clearing or repairing tasks easily.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional stacking structure for breeding chests.

FIG. 2 is a schematic view of breeding chests stacked by a conventional stacking structure shown in FIG. 1.

FIG. 3 is a fragmentary exploded view of the stacking structure of the present invention.

FIG. 4 is a schematic view of the stacking structure of the invention in an assembled condition.

FIG. 5 is a schematic view of breeding chests stacked by the stacking structure of the invention.

FIG. 6 is a fragmentary enlarged view of the stacking structure of the present invention.

FIGS. 7 through 12 are schematic views of other embodiments of the second bracing rods of the present invention.

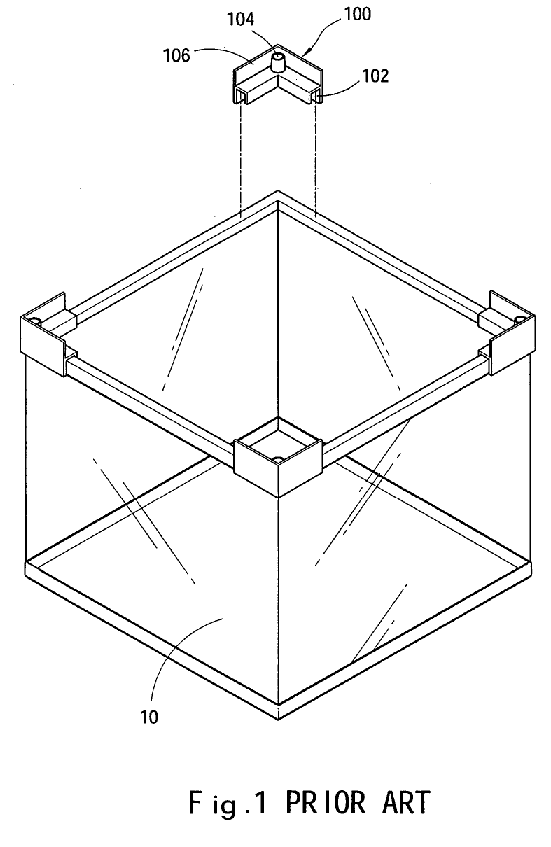

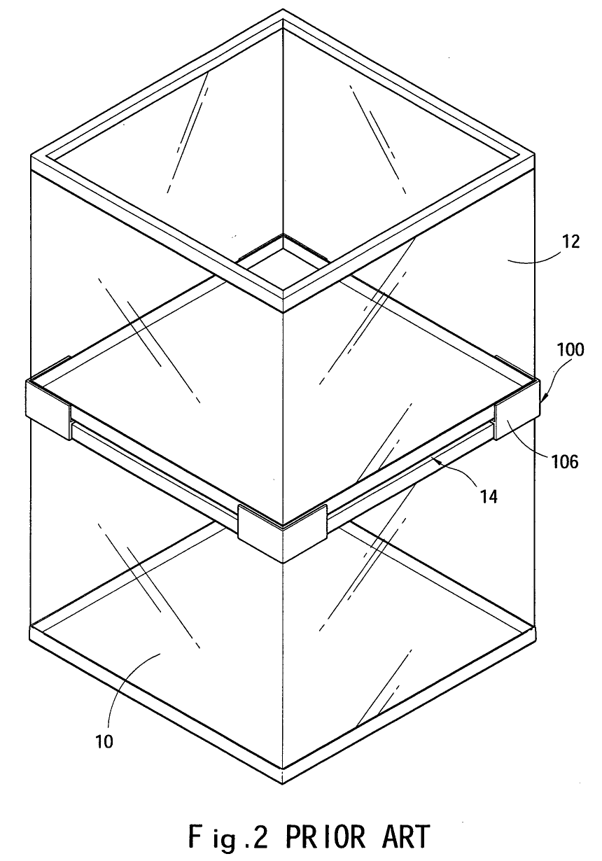

### DETAILED DESCRIPTION OF THE PREFERRED EMBODIMENTS

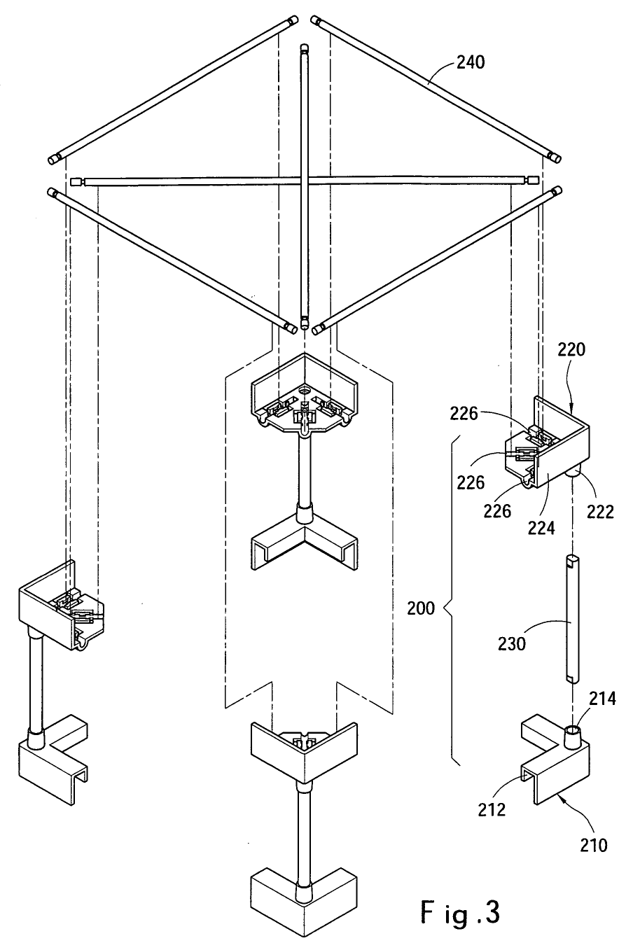

Please referring to FIGS. 3, 4 and 5, the stacking structure 200 of the present invention mainly includes four mounting members 210, four holding members 220, four first bracing rods 230 and six second bracing rods 240. Each of the mounting members 210 has a coupling trench 212 on the bottom to couple with a upped edge of a lower layer breeding chest 20, especially on a corner of the upper edge of the lower layer breeding chest 20 to achieve a secure coupling. The coupling trench 212 may have a washer (not shown in the drawings) located therein. In addition, each mounting member 210 has a first coupling duct 214 on the top and each holding member 220 has a second coupling duct 222 on the bottom that correspond to and couple with two ends of the first bracing rod 230 to bridge the mounting member 210 and the holding member 220. Each holding member 220 has a retaining flange 224 to cover the side wall of a upper layer breeding chest 22 to anchor the upper layer breeding chest 22 on the holding members 220. Each holding member 220 has three wedge troughs 226 to couple with the distal ends of the second bracing rods 240 to support the bottom of the upper breeding chest 22 and increase the loading capability. The first bracing rods 230 bridge the mounting members 210 and the holding members 220 to form an access space 24 therebween, and breeders can easily access the lower layer breeding chest 20 to do breeding, clearing or repairing tasks without removing the upper layer breeding chest 22, thereby improve convenience.

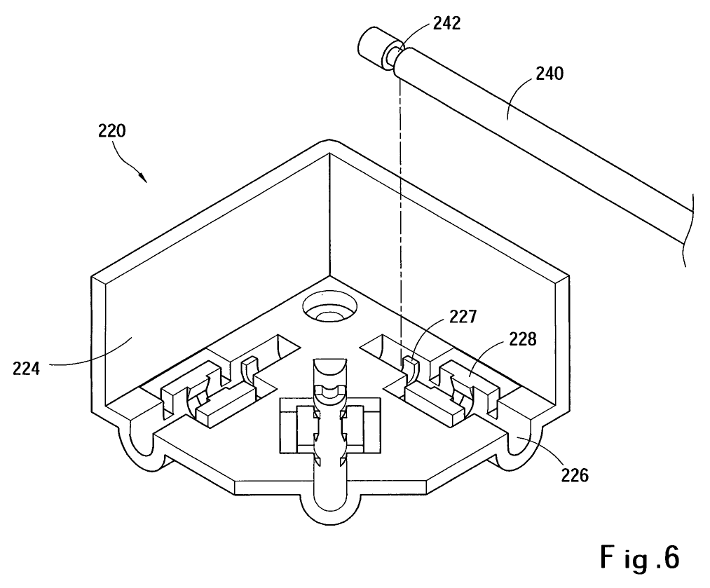

Referring to FIG. 6, the wedge trough 226 on the holding member 220 may further include a retaining member 227, and the distal end of the second bracing rod 240 may have a shrunk neck 242 to couple with the retaining member 227 to form a mechanical latching to inhibit the horizontal movement of the second bracing rod 240. In addition, the wedge trough 226 may have a pair of clipping members 228 to clip the distal end of the second bracing rod 240 to prevent the second bracing rod 240 from moving vertically. In short, the wedge trough 226 may have a retaining member 227 or clipping members 228 to anchor the second bracing rod 240 more securely in the wedge trough 226.

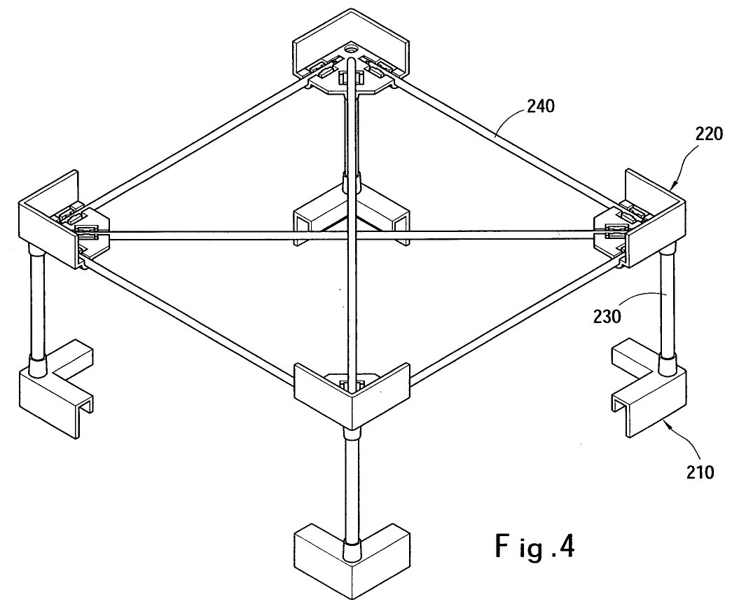

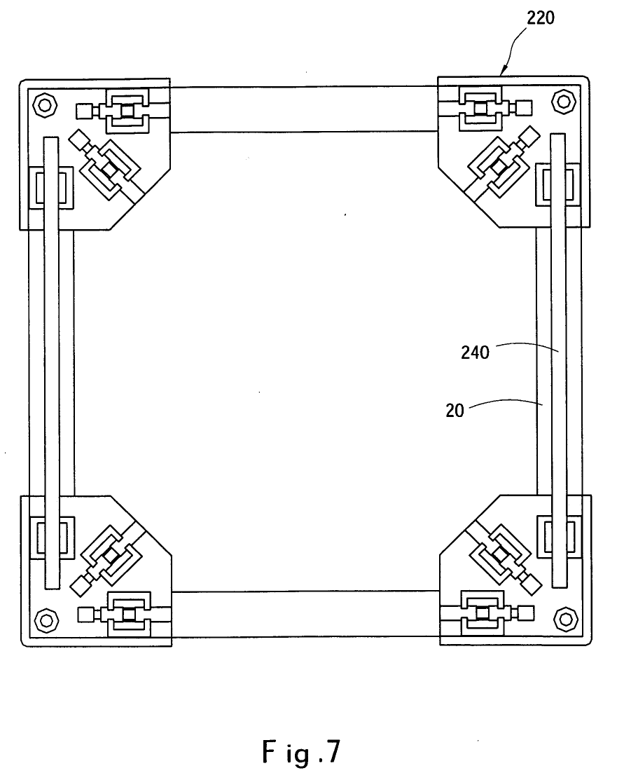

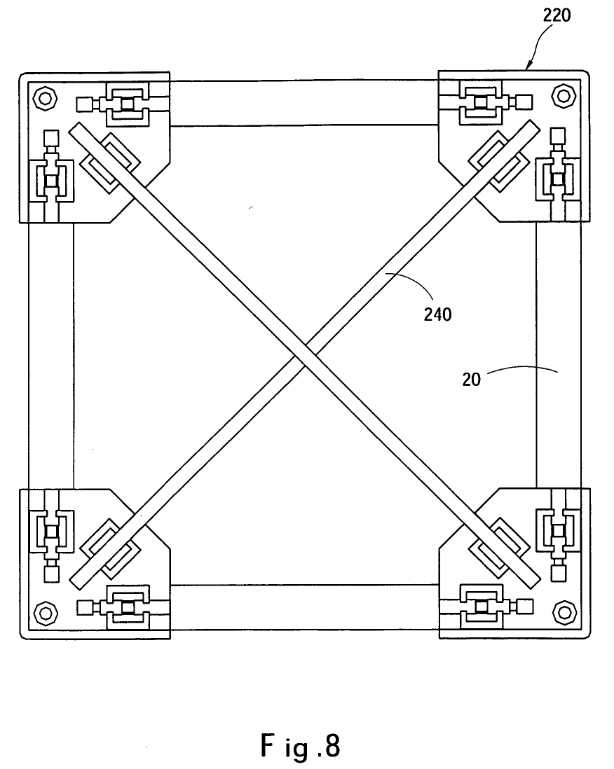

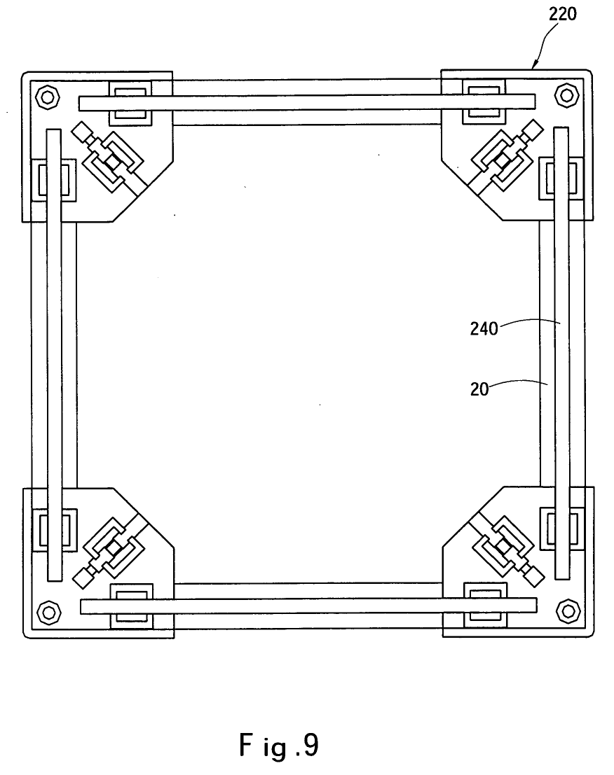

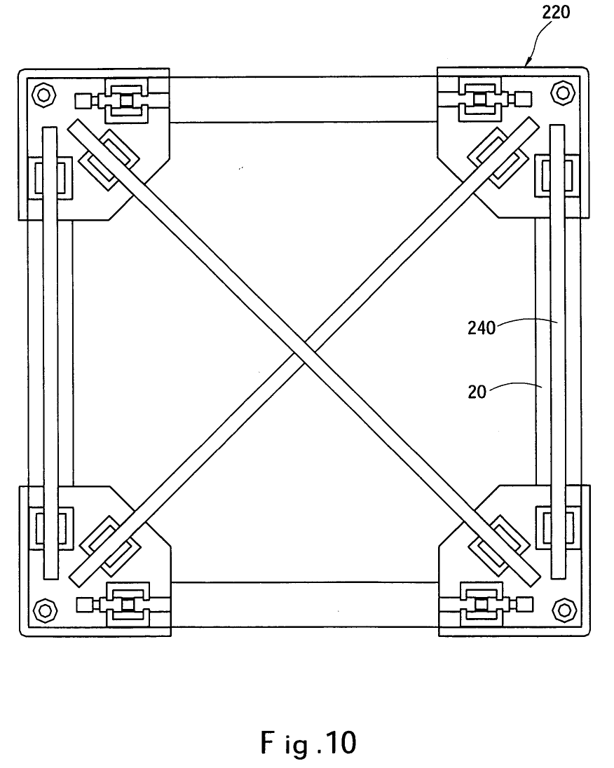

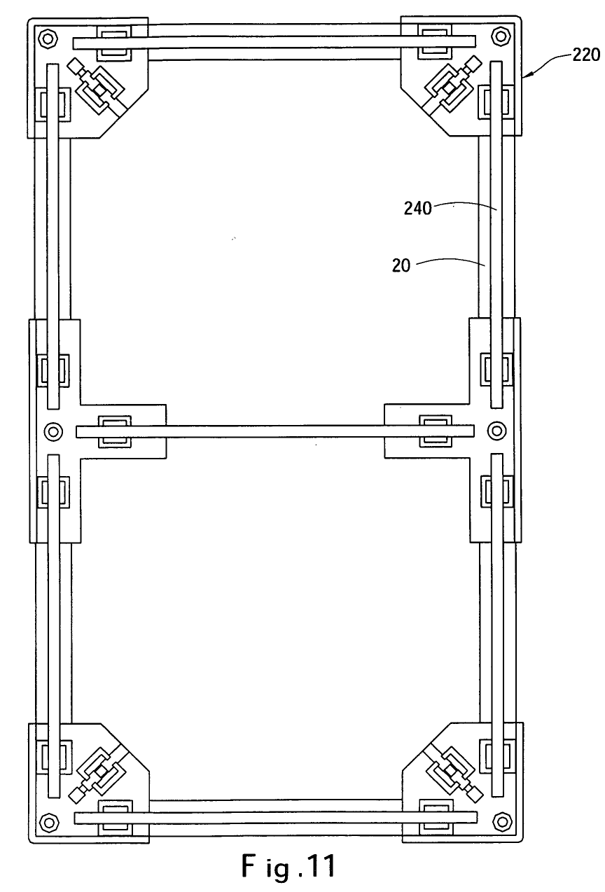

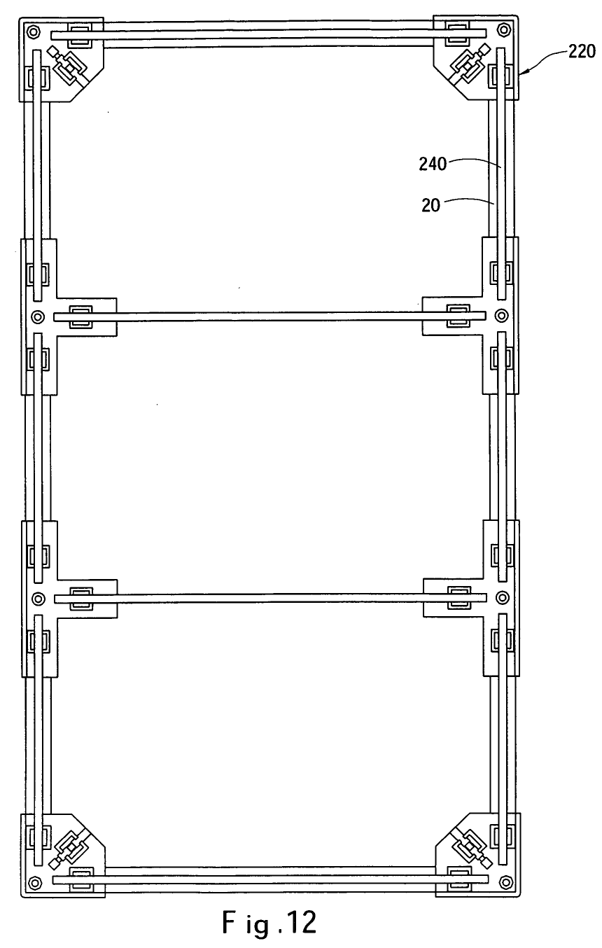

Refer to FIGS. 7 through 12 for other embodiments of the second bracing rods 240 of the invention. The number of the second bracing members 240 is not limited. They may be configured by two or four in a symmetrical manner to achieve the bracing effect. Moreover, referring to FIGS. 3 and 4, there is also no limitation on the number of the mounting members 210, holding members 220, first bracing members 230 and second bracing members 240. They may be configured as required according to the profile (such as triangle, square or polygon) of the breeding chest.

Also referring to FIGS. 3 and 4, the second bracing rods 240 may be dispensed with as long as the weight of the upper breeding chest 22 is bearable, and only the holding members 220 are provided to support the upper layer breeding chest 22. To those skilled in the art, it is also possible to replace the mounting members 210 with the side frames of the same shape on the lower breeding chest 20 (not shown in the drawings). The side frames also have coupling trenches formed on the bottom to couple with the upper edge of the lower layer breeding chest 20. And the holding members 220 may be replaced by a tray (not shown in the drawings) to support the upper layer breeding chest 22.

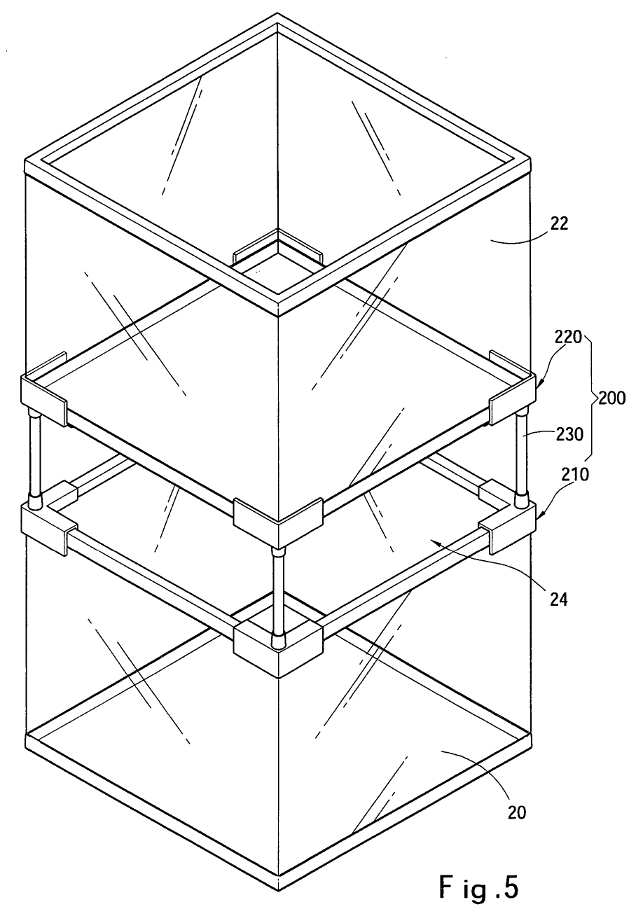

Referring to FIGS. 4 and 5, the first bracing rod 230 may also be extendable to adjust the size of the access space 24. For instance, the lower layer breeding chest 20 may be coupled with a lid (not shown in the drawings). By altering the height of the first bracing rods 230, the access space 24 may be adjusted without removing the upper layer breeding chest 22 to open or close the lid, and the length may be adjusted according to different sizes of the breeding chests to improve the practicality of the product.

Referring to FIGS. 3, 4 and 5, the mounting member 210 of the invention are coupled on the lower layer breeding chest 20 with the first bracing rods 230 and the second bracing rods 240 anchored by wedging. To those skilled in the art, it is obvious that there is no limitation on the assembly method of the mounting members 210, first bracing rods 230 and second bracing rods 240. Any assembly method that can couple and be disassembled may be adopted. For instance, two ends of the first bracing rod 230 and the first coupling duct 214 and second coupling duct 222 may have corresponding male and female screw treads (not shown in the drawings) to couple with each other by screwing.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A stacking structure for breeding chests, comprising:
a plurality of mounting members detachably located on a upper edge of a lower layer breeding chest;
a plurality of holding members detachably located on the bottom of a upper layer breeding chest; and
a plurality of first bracing rods detachably bridged the mounting members and the holding members to form an access space between the breeding chests.

2. The stacking structure for breeding chests of claim 1, wherein each of the mounting members has a coupling trench on the bottom thereof to couple on the upper edge of the lower layer breeding chest.

3. The stacking structure for breeding chests of claim 2, wherein the coupling trench has a washer to increase coupling tightness of the coupling trench and. the lower layer breeding chest.

4. The stacking structure for breeding chests of claim 1, wherein each of the mounting members has a first coupling duct on the top, and each of the holding members has a second coupling duct on the bottom, and each of the first bracing rods has two ends wedging in the first coupling duct and the second coupling duct.

5. The stacking structure for breeding chests of claim 1, wherein each of the holding members has a retaining flange to cover a side wall of the upper layer breeding chest.

6. The stacking structure for breeding chests of claim 1, wherein the first bracing rods are extendable for adjusting the size of the access space.

7. The stacking structure for breeding chests of claim 1 further including a plurality of second bracing rods detachably bridging the holding members to support the upper layer breeding chest.

8. The stacking structure for breeding chests of claim 7, wherein each of the holding members has a plurality of wedge troughs to couple with distal ends of second bracing rods.

9. The stacking structure for breeding chests of claim 8, wherein each of the wedge troughs has a retaining member, and each of the second bracing rods has a distal end which has a shrunk neck to couple with the retaining member.

10. The stacking structure for breeding chests of claim 8, wherein each of the wedge troughs has a pair of clipping members to couple with one distal end of the second bracing member.

11. The stacking structure for breeding chests of claim 7, wherein the second bracing members are extendable to couple with the breeding chests of varying sizes.

12. The stacking structure for breeding chests of claim 1, wherein the mounting members are replaced by a side frame which has a coupling trench on the bottom to couple on the upper edge of the lower layer breeding chest.

13. The stacking structure for breeding chests of claim 1, wherein the holding members are replaced by a tray to support the upper layer breeding chest.
